(19) United States
(12) Patent Application Publication
(10) Pub. No.: US 2016/0001214 A1
(43) Pub. Date: Jan. 7, 2016

(54) MANEUVERABLE AIR PURIFICATION DEVICE

(71) Applicant: Yun-Yueh Chen, Taichung City (TW)

(72) Inventor: Yun-Yueh Chen, Taichung City (TW)

(21) Appl. No.: 14/745,466

(22) Filed: Jun. 22, 2015

(30) Foreign Application Priority Data
Jul. 3, 2014 (TW) 103122959

(51) Int. Cl. B01D 50/00; B01D 46/00; B01D 47/06

(52) U.S. Cl. CPC B01D 50/006; B01D 50/008; B01D 47/06; B01D 46/0013; B01D 46/0039

(57) ABSTRACT

A maneuverable air purification device includes an automobile assembly and an air purification assembly movable thereby. The air purification assembly includes a barrel mounted on the automobile body. The barrel has an intermediate section in which a necked and reduced channel compression section is formed. The barrel has two ends that are respectively an air drawing opening corresponding a tail end of the automobile body and an air discharge opening. The barrel includes a filter arranged in the channel compression section. The chamber of the barrel includes a sprayer at one side of the filter corresponding to the air discharge opening. The chamber of the barrel includes a blower arranged therein at a location adjacent to the air discharge opening.

### (a) TECHNICAL FIELD OF THE INVENTION

The present invention relates generally to a technical field of treatment of air pollution, and more particularly to a maneuverable air purification device, which provides improved maneuverability and performance of clearing powder dirt contained in air so as to effectively reduce harmful substances contained in air.

### (b) DESCRIPTION OF THE PRIOR ART

Air pollution is contamination of atmosphere caused by substances that are harmful to human bodies and the surrounding environment. Such harmful substances could be gaseous, solid, or liquid suspended matters. The causes of air pollution include powdery dirt resulting from over-development constructions, particles suspending in air, exhaust gases discharged from automobiles, and toxicant gases released from industrial sites. According to PSI (Pollutant Standard Index) standards, when the value of PSI exceeds 100, the human bodies may perceive irritation and the situation would be worse or even cause activity deterioration for sensitive people, and may even causes accelerated death for the elder and people having poor health. Thus, people are often advised to reduce the possibility and time interval of getting outdoors and even not to take any outdoor activity when the value of PSI is high.

If the amount of contaminants in the atmosphere could be reduced, then the influence of air pollution on human bodies and the surrounding environment can be alleviated to some extents. Thus, when the contaminants or pollutants are increased to a hazardous level, measures must be taken to remove such contaminants or pollutants from air. Commonly adopted measures include street water-spraying trucks and air purification devices. The street water-spraying trucks are used to spray water on street surfaces in order to reduce dust lifting from the street surfaces and suspending in air. This is generally of no help in improving air quality, for once the water is dried, dusts resume lifting from the street surface, so that the result is poor. As to air purification devices, they are generally of a small air flowrate and are used indoors and do not help for clearing mass air pollution outdoors.

### SUMMARY OF THE INVENTION

Thus, the primary object of the preset invention is to provide a maneuverable air purification device that causes relative air flowing during movement thereof to allow air to be guided therein in an efficient and massive manner in order to effectively filter off powdery dirt contained in air and thus improving air quality.

In a use of the maneuverable air purification device of the present invention, through an arrangement of a channel compression section in a chamber of a barrel of an air purification assembly, air flowing can be accelerated. An air drawing opening arranged at a tail end of an automobile body allows surrounding air to be drawn into the chamber of the barrel to increase the amount of air intake. As such, the capacity is expanded and the speed is increased so that the capability of treating air for purification is increased. Further, the high helical compression filter produces a powerful centrifugal force through helix thereof to further improve the capability of filtering dust so as to effectively carry out air purification outdoors and thus overcoming the issue of incapable of handling outdoor air filtering for the known techniques, thereby improving practical use thereof and heightening the added value thereof to achieve improved economic effectiveness.

The foregoing objectives and summary provide only a brief introduction to the present invention. To hilly appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is a cross-sectional view, in a schematic and simplified form, showing the structure of the present invention.

FIG. 3 is a schematic view illustrating air flows induced in the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

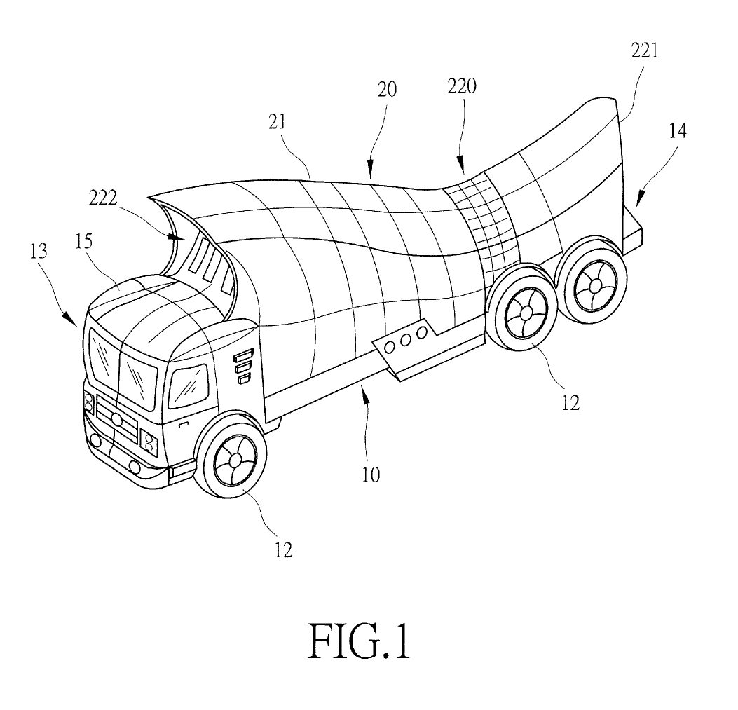

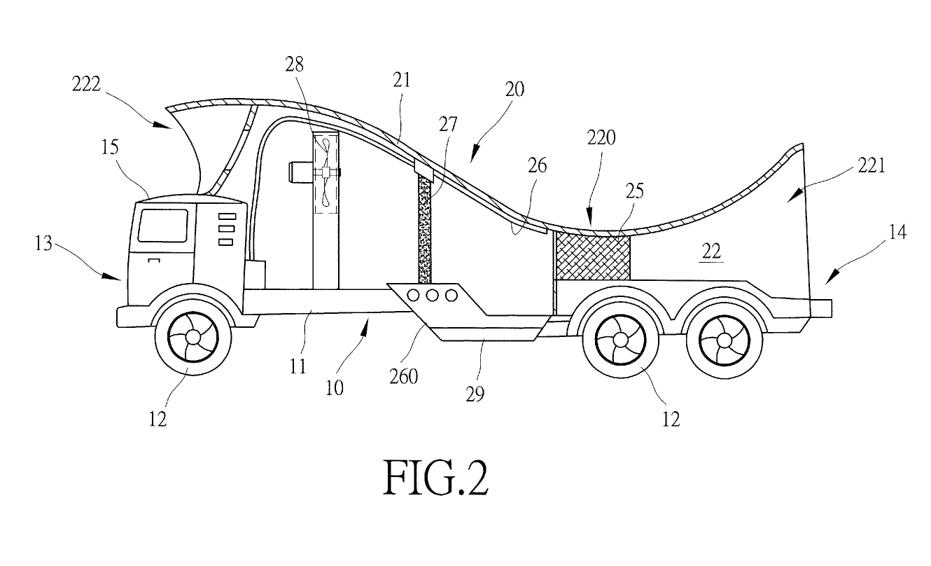

The present invention provides a maneuverable air purification device, of which a structure is illustrated in FIGS. 1 and 2, comprising an automobile assembly 10 and an air purification assembly 20 that is movable thereby.

A detailed description will be given to the structure of the present invention with reference to FIGS. 1 and 2. The automobile assembly 10 comprises an automobile body 11 that supports and carries thereon the air purification assembly 20. The automobile body 11 has a lower side on which a plurality of wheels 12 is mounted for moving the automobile assembly 10. Further, the automobile body 11 of the automobile assembly 10 has two opposite ends, which are respectively referred to as an advancing end or a front end 13 and a tail end 14. According to the present invention, the automobile assembly 10 comprises a power automobile head 15 that is arranged at the front end 13 of the automobile body 11 for supplying power to drive and control a forward movement of the automobile assembly 10.

The air purification assembly 20 comprises a barrel 21 that is mounted on the automobile body 11 of the automobile assembly 10. The barrel 21 comprises, in an interior thereof, a hollow chamber 22 that extends through two ends thereof. The chamber 22 of the barrel 21 has an intermediate section that is structured to form a necked and reduced channel compression section 220, which uses the principle of Venturi tube to accelerate air flows and increase flow rates and also to concentrate and compact dust for filtering to thereby improve the purification capacity and purification extent. Further, the chamber 22 of the barrel 21 has two opposite ends that are respectively referred to as an air drawing opening 221 and an air discharge opening 222. The air purification assembly 20 is mounted on the automobile assembly 10 in such a way that the air drawing opening 221 of the chamber 22 of the barrel 21 corresponds to the tail end 14 of the automobile body 11 and the air discharge opening 222 of the chamber 22 of the barrel 21 corresponds to the front end 13 of the automobile body 11. In addition, the air discharge opening 222 is arranged not to face the power automobile head 15 in order to reduce the resistance against discharging of air. Further, the barrel 21 comprises a filter 25 arranged in the channel compression section 220 of the chamber 22 and the filter 25 may be a high helical compression filter, which induces a powerful centrifugal force through helix for densifying and compacting the dust for concentrated filtering. The filter 25 is structured to filter off powdery dusts having a particle size greater than 10 μm. Further, the chamber 22 of the barrel 21 comprises a sprayer 26 that is arranged at a top side on the side of the filter 25 corresponding to the air discharge opening 222. To achieve high percentage of micro-particle powdery dust falling down, the sprayer 26 is preferably arranged to spray water downward at an angle of 35 degrees to 55 degrees. A preferable angle of the sprayer is to generate pressurized air mist at 45 degrees in a top-down manner to spray powdery dusts having a great specific weight downward. Further, the barrel 21 comprises a water tank 260 arranged at a lower side thereof to supply water to the sprayer 26. Further, the barrel 21 comprises a dust collection tank 29 arranged below the sprayer 26 to collect powdery dusts. The dust collection tank 29 is connected, via a filter assembly, to the water tank 260 to allow the dust-entraining water collected in the dust collection tank 29 to be filtered and guided back into the water tank 260 for repeated use by the sprayer 26. Further, the chamber 22 of the barrel 21 comprises a filter screen assembly 27 arranged at one side of the sprayer 26 that corresponds to the air discharge opening 222. The filter screen assembly 27 may be a catalyzer converter based filter, which functions to filter off carbon monoxide of exhaust gases of automobiles and motorcycles. Further, the chamber 22 of the barrel 21 comprises a blower 28 arranged therein at a location adjacent to the air discharge opening 222 for driving air to be drawn through the air drawing opening 221 of the barrel 21 and to be discharged through the air discharge opening 222.

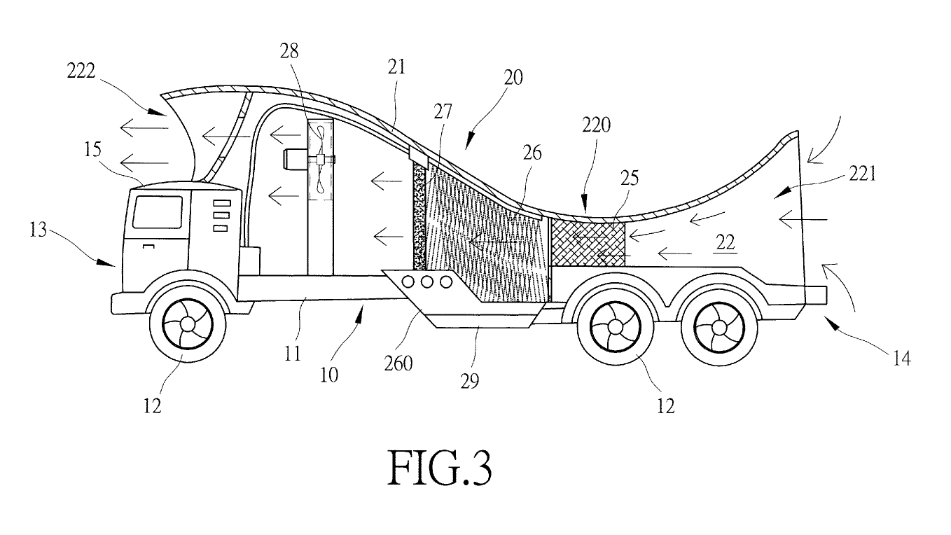

As such, the air purification assembly 20 can be movable by being carried on and transported by the automobile assembly 10. The filter 25, the sprayer 26 and the filter screen assembly 27 of the air purification assembly 20 are operable to sequentially filter air so as to provide a maneuverable air purification device of high maneuverability and efficiency. With the above-described structure, in practical uses of the maneuverable air purification device according to the present invention, as shown in FIGS. 1 and 3, to operate, the power automobile head 15 of the automobile assembly 10 is operated to transport and thus move the automobile body 11 so as to allow the air purification assembly 20 carried on the automobile body 11 to be moved, in a maneuverable manner, on streets at a predetermined speed.

When the blower 28 of the chamber 22 of the barrel 21 of the air purification assembly 20 is activated, air located in the chamber 22 starts to flow so that polluted air may be drawn in through the air drawing opening 221 and the air flow is accelerated and compressed by the Venturi tube constructed with the necked and reduced configuration of the channel compression section 220 so as to increase air intake and improve the performance of dust filtering. Further, when air passes through the filter 25 inside the chamber 22 of the barrel 21, the filter 25 generates a powerful centrifugal force through helix thereof to compact and concentrate dusts for treatment of filtering, which first filters off dusts having a particles size greater than 10 μm. Afterwards, pressurized air mist sprayed from the sprayer 26 at an angle of 45 degrees in direction from top to bottom functions to spray downward dusts of various specific weights so as to have the dust collected in the dust collection tank 29 and the filter assembly is operable to filter the dust-entraining water and conducted the filtered water back into the water tank 260 for repeated use by the sprayer 26. When the filtered air moves through the filter screen assembly 27 that comprises a catalytic converter based filter screen, the concentration of carbon monoxide contained in exhaust gases of automobiles and motorcycles can be further reduced. Air is finally discharged through the air discharge opening 222 of the barrel 21 to thereby achieve the purpose of filtering air in a maneuverable and massive manner.

It can be appreciated from the above description that the maneuverable air purification device of the present invention, when put into use, is allowed to move along streets of a city, preferably at a slow speed. Through the arrangement of the channel compression section 220 in the chamber 22 of the barrel 21 of the air purification assembly 20, air flowing can be accelerated. The air drawing opening 221 arranged at the tail end 14 of the automobile body 11 allows surrounding air to be drawn into the chamber 22 of the barrel 21 to increase the amount of air intake. As such, the capacity is expanded and the speed is increased so that the capability of treating air for purification is increased. Further, the high helical compression filter 25 produces a powerful centrifugal force through helix thereof to further improve the capability of filtering dust so as to effectively carry out air purification outdoors and thus overcoming the issue of incapable of handling outdoor air filtering for the known techniques, thereby improving practical use thereof and heightening the added value thereof to achieve improved economic effectiveness.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A maneuverable air purification device, comprising:
an automobile assembly, which comprises an automobile body, the automobile body comprising a plurality of wheels mounted to a lower side thereof for movement, the automobile body of the automobile assembly having two ends that are respectively a front end and a tail end; and
an air purification assembly, which comprises a barrel mounted on the automobile body, the barrel comprising a hollow chamber formed therein to extend through two ends thereof, the chamber of the barrel having an intermediate section in which a necked and reduced channel compression section is formed, the chamber of the barrel having two ends that are respectively an air drawing opening and an air discharge opening, wherein the air drawing opening corresponds to the tail end of the automobile body and the air discharge opening corresponds to the front end of the automobile body, the barrel comprising a filter arranged in the channel compression section of the chamber, the chamber of the barrel comprising a sprayer arranged on a top of one side of the filter corresponding to the air discharge opening to spray down dusts of various specific weights in a direction from top to bottom, the barrel comprising a water tank for supplying water to the sprayer, the barrel comprising a dust collection tank arranged below the sprayer for collecting the dusts, the chamber of the barrel comprising a blower arranged at a location adjacent to the air discharge opening for driving air in such a way to draw air in through the air drawing opening and to discharge air through the air discharge opening.

2. The maneuverable air purification device according to claim 1, wherein the automobile assembly comprises a power automobile head arranged at the front end of the automobile body for driving and controlling movement of the automobile assembly.

3. The maneuverable air purification device according to claim 1, wherein the filter the air purification assembly comprises a high helical compression filter, which induces a centrifugal force through helix thereof to compact and concentrate dusts for filtering.

4. The maneuverable air purification device according to claim 1, wherein the sprayer of the air purification assembly is arranged to spray down at an angle of 35-55 degrees.

5. The maneuverable air purification device according to claim 1, wherein the sprayer of the air purification assembly is arranged to spray down at an angle of 45 degrees.

6. The maneuverable air purification device according to claim 1, wherein the dust collection tank of the air purification assembly is connected via a filter assembly to the water tank.

7. The maneuverable air purification device according to claim 1, wherein the chamber of the barrel of the air purification assembly comprises a filter screen assembly arranged at one side of sprayer that corresponds to the air discharge opening, the filter screen assembly comprising a catalytic converter based filter screen for reducing concentration of carbon monoxide of exhaust gases of automobiles and motorcycles.

8. A maneuverable air purification device, comprising an air purification assembly canyable by an automobile;
wherein the air purification assembly comprises a barrel, the barrel comprising a hollow chamber formed therein to extend through two ends thereof, the chamber of the barrel having an intermediate section in which a necked and reduced channel compression section is formed, the chamber of the barrel having two ends that are respectively an air drawing opening and an air discharge opening, wherein the air drawing opening corresponds to an end of the automobile opposite to an advancing direction thereof and the air discharge opening corresponds to an end of the automobile in the advancing direction, the barrel comprising a filter arranged in the channel compression section of the chamber, the chamber of the barrel comprising a sprayer arranged on a top of one side of the filter corresponding to the air discharge opening to spray down dusts of various specific weights in a direction from top to bottom, the barrel comprising a water tank for supplying water to the sprayer, the barrel comprising a dust collection tank arranged below the sprayer for collecting the dusts, the chamber of the barrel comprising a blower arranged at a location adjacent to the air discharge opening for driving air in such a way to draw air in through the air drawing opening and to discharge air through the air discharge opening.

9. The maneuverable air purification device according to claim 8, wherein the filter the air purification assembly comprises a high helical compression filter, which induces a centrifugal force through helix thereof to compact and concentrate dusts for filtering.

10. The maneuverable air purification device according to claim 8, wherein the sprayer of the air purification assembly is arranged to spray down at an angle of 35-55 degrees.

11. The maneuverable air purification device according to claim 8, wherein the sprayer of the air purification assembly is arranged to spray down at an angle of 45 degrees.

12. The maneuverable air purification device according to claim 8, wherein the dust collection tank of the air purification assembly is connected via a filter assembly to the water tank.

13. The maneuverable air purification device according to claim 8, wherein the chamber of the barrel of the air purification assembly comprises a filter screen assembly arranged at one side of sprayer that corresponds to the air discharge opening, the filter screen assembly comprising a catalytic converter based filter screen for reducing concentration of carbon monoxide of exhaust gases of automobiles and motorcycles.
